(19) United States
(12) Patent Application Publication
(10) Pub. No.: US 2016/0209635 A1
(43) Pub. Date: Jul. 21, 2016

(54) Cell Phone Microscope System

(71) Applicant: Juan YAN, GUANGDONG (CN)

(72) Inventor: Juan YAN, GUANGDONG (CN)

(21) Appl. No.: 14/621,407

(22) Filed: Feb. 13, 2015

(30) Foreign Application Priority Data
Jan. 21, 2015 (CN) 201520043071.X

(51) Int. Cl. G02B 21/36; G02B 21/06; G02B 7/02; G02B 21/02

(52) U.S. Cl. CPC G02B 21/362; G02B 21/02; G02B 21/06; G02B 7/02

(57) ABSTRACT

A cell phone microscope system, including lens and lens-clamping fixture. The lens-clamping fixture is equipped with a mounting hole, and the lens is mounted in the hole. The lens at least includes two pieces of glued lens. The glued lens is plated with anti-reflective film, and there is a lens aperture between the two pieces of glued lens. The cell phone microscope system is characterized by realistic imaging, large depth of field, clear imaging and convenient focusing.

### BACKGROUND OF THE INVENTION

The utility model involves a microscope, in particular, cell phone microscope system.

Microscope technology, widely used in the clinical examination, has become an essential common viewer in the medical industry. At present, most hospitals use desktop microscope, which is a traditional microscope, based on pure optical amplification, with a high amplification factor and good imaging quality, but not convenient for movement, outing or field-based test due to its large volume. Along with the development of electronic information technology, various electron microscopes will extend the microscope market to various fields, e.g. micro-electronics manufacturing industry, where electron microscope is generally used to observe the tiny circuit devices, which, to a great extent, depends on the powerful image processing function of computer, unsuitable for design and display of micro-electronic products on the transaction site. Therefore, portable microscope, to some extent, is popular among the users, which is easy-to-carry and able to customize various services, e.g. allowing access to videos and photos or image contrast and measurement. However, the portability is just compared to that of traditional microscope. As a microscopic device in the specific field, its applicability is under great restrictions, and its operation also requires certain specialized knowledge. The flourishing of cell phone market has opened up a new market for various industries. As a common communication device, cell phone is portable, with constant improvement in the image processing function and information processing capacity, so the microscope system with cell phone as the carrier has been increasingly highlighting its position in the future microscope market, not only suitable for the public, but also convenient to use and easy to operate, with synchronous application of the function and the information technology.

In the market at present, cell phone microscope acquires the seriously distorted images through the lens combination of external amplification function, and restricted by the cell phone camera size, the depth of field of microscope imaging is adjustable only in a small range. In different environments, due to the change in the light intensity, it is difficult for the cell phone microscope to achieve clear imaging, with operation inconvenience due to the complicate optical focusing structure of cell phone camera and microscope.

### BRIEF SUMMARY OF THE INVENTION

The utility model is to overcome the existing technical problems, and to provide a cell phone microscope system characterized by realistic imaging, large depth of field, clear imaging and convenient focusing.

The technical solution of the utility model depends on the cell phone microscope system of the utility model, including lens and lens-clamping fixture. The said lens-clamping fixture is equipped with a mounting hole, and the said lens is mounted in the hole. The improvement is as follows: the said lens at least includes two pieces of glued lens, where the glued lens is plated with anti-reflective film, and there is a lens aperture between the two pieces of glued lens.

In the above-mentioned structure, the said lens aperture is equipped with a spacer ring, and the two pieces of glued lens are spaced in the spacer ring respectively.

In the above-mentioned structure, the said lens-clamping fixture includes the clamping fixture body and the elastic indenter, where there is a magnet at the clamping fixture body, there is an iron at the elastic indenter and the magnet, and there is an elastic indenter spindle between the elastic indenter and the clamping fixture body.

In the above-mentioned structure, the said lens-clamping fixture is also equipped with a standby lens mounting hole, which is dismountable, connected to a standby lens.

In the above-mentioned structure, the said lens-clamping fixture is also equipped with a lighting system, which is connected flexibly to the lens-clamping fixture via an illumination spindle.

In the above-mentioned structure, the lighting system includes the illumination cover, luminescent system and reflector, where the reflector is connected to the illumination cover spindle, and the rays of the luminescent system are reflected via the reflector.

In the above-mentioned structure, the reflector includes three different reflecting surfaces, i.e. mirror surface, cloudy surface and V-shaped surface, where the mirror surface can achieve the total reflection, the cloudy surface can achieve the scattering, and the V-shaped surface can achieve the light splitting.

In the above-mentioned structure, the luminescent system is located inside the illumination cover, including the illumination power source and the LED lamp, where the illumination power source is electrically connected to the LED lamp.

Beneficially, the utility model can provide a cell phone microscope system characterized by realistic imaging, large depth of field, clear imaging and convenient focusing.

### BRIEF DESCRIPTION OF THE DRAWINGS

FIG. 1 is the structural diagram of the cell phone microscope system in the utility model.

FIG. 2 is the front view of the cell phone microscope system in the utility model.

FIG. 3 is the profile of A-A in FIG. 2.

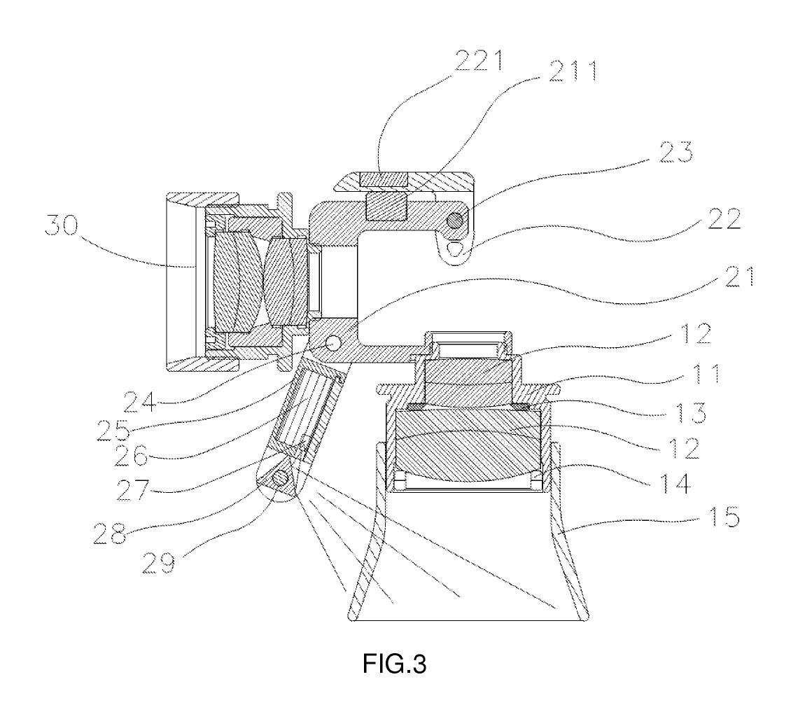

In the figure: 10. Lens, 20. Lens-clamping fixture, 30. Standby lens, 11. Lens outrigger, 12. Glued lens, 13. Lens aperture, 14. Lens forcing screw, 15. Diffuser, 21. Lens-clamping fixture body, 22. Elastic indenter, 23. Elastic indenter spindle, 24. Illumination spindle, 25. Illumination cover, 26. Illumination power source, 27. LED lamp, 28. Reflector, 29. Reflector spindle, 211. Magnet, 221. Iron.

### DETAILED DESCRIPTION OF THE INVENTION

The utility model will be further described in combination with the figures and the specific implementation modes below:

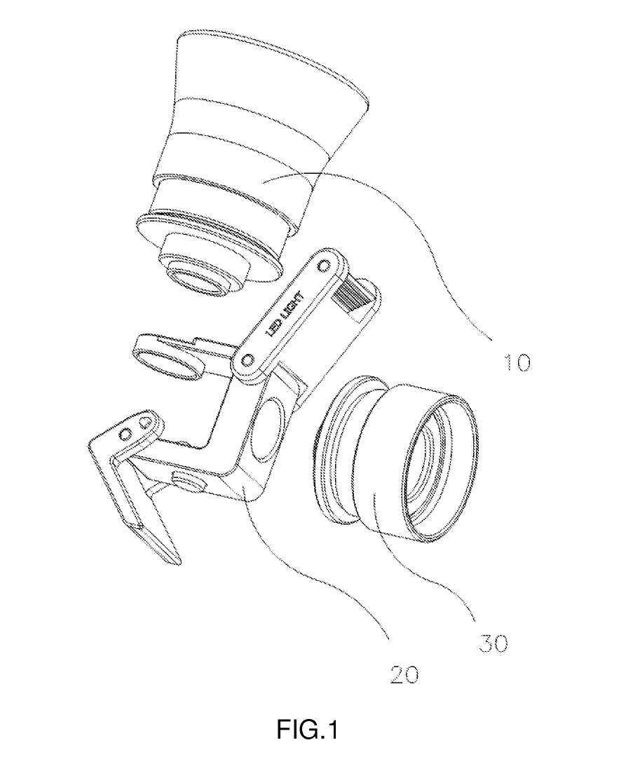

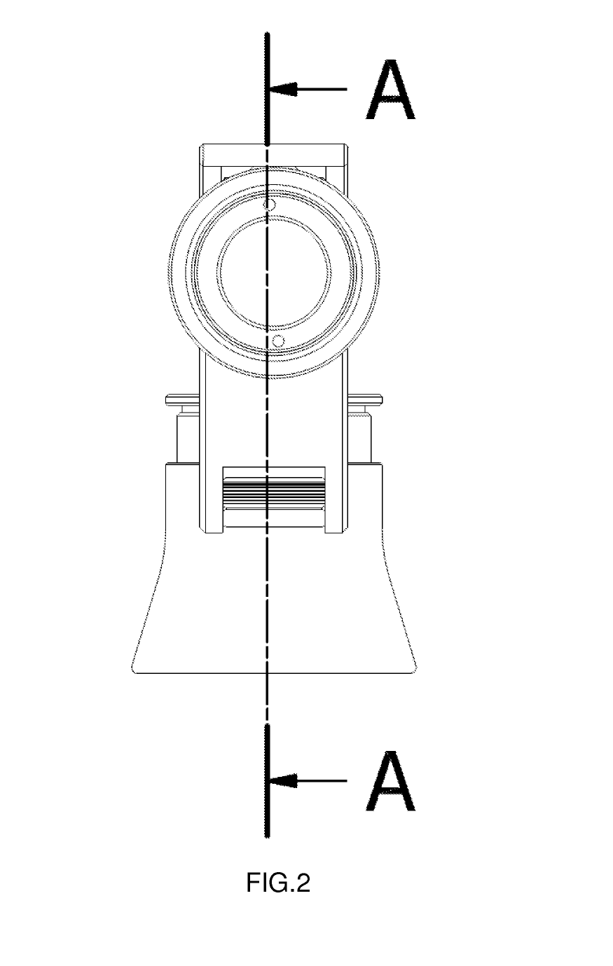

As shown in FIG. 1 and FIG. 2, the cell phone microscope system indicated in the utility model includes the lens (10) and the lens-clamping fixture (20). The lens-clamping fixture (20) is equipped with a mounting hole, and the lens (10) is mounted in the hole. The lens (10) at least includes two pieces of glued lens (12), constituting the objective lens and eye lens of the lens (10) respectively, where the glued lens (12) is plated with anti-reflective film, so that the lens (10) can catch sight of clear and authentic images, and there is a lens aperture (13) between the two pieces of glued lens (12) to increase the depth of field of the lens (10).

In the above-mentioned structure, the lens aperture (13) is equipped with a spacer ring, and the two pieces of glued lens (12) are spaced in the spaced ring respectively to control the distance between the two pieces of glued lens (12) by adjusting the lens aperture (13), so as to adjust the depth of field. In order to prevent the glued lens (12) in the lens (10) from loosening, lens forcing screw (14) is mounted on the lens outrigger (11).

In the above-mentioned structure, the lens-clamping fixture (20) includes the clamping fixture body (21) and the elastic indenter (22), where there is a magnet (211) at the clamping fixture body (21), there is an iron (221) at the elastic indenter (22) and the magnet (211), and there is an elastic indenter spindle (23) between the elastic indenter (22) and the clamping fixture body (21). Thanks to such structure, the lens-clamping fixture (20) can be used for the cell phone of different models, and the lens (10) can focus with the cell phone camera more easily.

Further, the lens-clamping fixture (20) is also equipped with a standby lens mounting hole, which is dismountable, connected to a standby lens (30), preferably in a screwed manner, convenient to replace the lens (10) or the standby lens (30). The amplification factor of the standby lens (30) may be different from that of the lens (10). Such diversified choice allows the lens to satisfy different demands in different environments.

Further, the lens-clamping fixture (20) is also equipped with a lighting system, which is connected flexibly to the lens-clamping fixture (20) via an illumination spindle (24). Such structure is flexible and can be adjusted simply.

Further, the lighting system includes the illumination cover (25), luminescent system and reflector (28). The reflector (28) is connected to the illumination cover (25) spindle, and the rays of the luminescent system are reflected via the reflector (28). The rays from the luminescent system are reflected to the diffuser (15) of the lens (10) in different forms via the reflector (28) by adjusting the reflector spindle (29). The diffuser (15) may be bell-mouthed, preferably connected to the lens outrigger (11) in the threaded manner, so that it can be used together with the standby lens (30), reducing the wasting of resources.

Further, the reflector (28) includes three different reflecting surfaces, i.e. mirror surface, cloudy surface and V-shaped surface, where the mirror surface can achieve the total reflection, the cloudy surface can achieve the scattering, and the V-shaped surface can achieve the light splitting, so that the cell phone microscope system can be used in different environments.

Further, the luminescent system is located inside the illumination cover (25), including the illumination power source (26) and the LED lamp (27), where the illumination power source (26) is electrically connected to the LED lamp (27).

The above is only the preferable implementation case of the utility model, which is not the restriction of the utility model. Any deformation and revision will be allowed within the technological thought scope of the utility model. Any polishing, revision or equivalent replacement by any ordinary technical staff in the field based on the above descriptions will belong to the scope of protection of the utility model.

What is claimed is:

1. A cell phone microscope system including lens and lens-clamping fixture; the lens-clamping fixture is equipped with a mounting hole, and the lens is mounted in the hole; wherein the lens at least includes two pieces of glued lens, where the glued lens is plated with anti-reflective film, and there is a lens aperture between the two pieces of glued lens.

2. The cell phone microscope system, as described in claim 1, wherein the lens aperture is equipped with a spacer ring, and the two pieces of glued lens are spaced in the spacer ring respectively.

3. The cell phone microscope system, as described in claim 1, wherein the lens-clamping fixture includes the clamping fixture body and the elastic indenter, where there is a magnet at the clamping fixture body, there is an iron at the elastic indenter and the magnet, and there is an elastic indenter spindle between the elastic indenter and the clamping fixture body.

4. The cell phone microscope system, as described in claim 1, wherein the lens-clamping fixture is also equipped with a standby lens mounting hole, which is dismountable, connected to a standby lens.

5. The cell phone microscope system, as described in claim 1, wherein the lens-clamping fixture is also equipped with a lighting system, which is connected flexibly to the lens-clamping fixture via an illumination spindle.

6. The cell phone microscope system, as described in claim 5, wherein the lighting system includes the illumination cover, luminescent system and reflector, where the reflector is connected to the illumination cover spindle, and the rays of the luminescent system are reflected via the reflector.

7. The cell phone microscope system, as described in claim 6, wherein the reflector includes three different reflecting surfaces: mirror surface, cloudy surface and V-shaped surface, where the mirror surface achieves the total reflection, the cloudy surface achieves the scattering, and the V-shaped surface achieves the light splitting.

8. The cell phone microscope system, as described in claim 6, wherein the luminescent system is located inside the illumination cover, including the illumination power source and the LED lamp, where the illumination power source is electrically connected to the LED lamp.

9. The cell phone microscope system, as described in claim 7, wherein the luminescent system is located inside the illumination cover, including the illumination power source and the LED lamp, where the illumination power source is electrically connected to the LED lamp.
